(19) United States
(12) Patent Application Publication
(10) Pub. No.: US 2014/0251280 A1
(43) Pub. Date: Sep. 11, 2014

(54) CONTROL APPARATUS FOR INTERNAL COMBUSTION ENGINE AND CONTROL METHOD FOR INTERNAL COMBUSTION ENGINE

(71) Applicant: Toyota Jidosha Kabushiki Kaisha, Toyota-shi, Aichi-ken (JP)

(72) Inventors: Takuya Ikoma, Miyoshi-shi (JP); Ryoji Tachibana, Toyota-shi (JP); Zenichiro Mashiki, Nisshin-shi (JP); Ryoji Abe, Anjo-shi (JP); Kenichi Saito, Nisshin-shi (JP); Tatsuhiko Akita, Okazaki-shi (JP); Tomoaki Honda, Gotenba-shi (JP); Yoshiaki Hamamoto, Toyota-shi (JP)

(73) Assignee: TOYOTA JIDOSHA KABUSHIKI KAISHA, Toyota-shi, Aichi-ken (JP)

(21) Appl. No.: 14/348,827

(22) PCT Filed: Nov. 22, 2012
(86) PCT No.: PCT/IB2012/002448

§ 371 Date: Mar. 31, 2014

(30) Foreign Application Priority Data
Nov. 25, 2011 (JP) 2011-257911

(51) Int. Cl. F02D 41/30

(52) U.S. Cl. CPC F02D 41/30
USPC 123/478

(57) ABSTRACT

A control apparatus that controls a fuel supply system of an internal combustion engine of a vehicle, the fuel supply system including a low-pressure fuel supply mechanism that injects low-pressure fuel into an intake port of the internal combustion engine, and a high-pressure fuel supply mechanism that injects high-pressure fuel into a cylinder of the internal combustion engine, includes a control portion that controls a supply of fuel to the internal combustion engine from the fuel supply system. Immediately after the vehicle stops, when the internal combustion engine satisfies a predetermined condition, the controller idles the internal combustion engine by supplying the high-pressure fuel to the internal combustion engine by the high-pressure fuel supply mechanism, and after stopping the supply of fuel by the high-pressure fuel supply mechanism, idles the internal combustion engine by supplying the low-pressure fuel to the internal combustion engine by the low-pressure fuel supply mechanism.

### BACKGROUND OF THE INVENTION

1. Field of the Invention

The invention relates to a control apparatus for an internal combustion engine, and a control method of an internal combustion engine.

2. Description of the Related Art

Among the different types of internal combustion engines for a vehicle, there is a so-called in-cylinder injection type internal combustion engine that is a spark ignition engine that injects fuel directly into the cylinders. This in-cylinder injection type engine is provided with a fuel supply system that supplies fuel into the cylinders.

In the fuel supply system, high-pressure fuel is accumulated and stored inside of a delivery pipe. This high-pressure fuel is injected directly into the cylinders at equal pressure from an injector provided in each cylinder. The fuel accumulated and stored in the delivery pipe is pressurized to a high pressure by being compressed by a high-pressure pump after being compressed by a feed pump. The intake amount of the high-pressure pump is controlled by an intake metering valve. This intake metering valve controls the fuel pressure inside the delivery pipe so that it follows a target fuel pressure according to the operating state of the engine.

In the in-cylinder injection type engine, the fuel pressure in a high-pressure fuel supply system from the high-pressure pump to the injectors is high. Therefore, after the engine has stopped, the fuel in the high-pressure fuel supply system may leak out from the injectors into the cylinders and vaporize in the cylinders, for example. If fuel vaporizes in the cylinders, the air-fuel mixture in the cylinders will become excessively rich, which may cause the performance when the engine is restarted to decrease.

One type of in-cylinder injection type engine that is being developed performs control to increase the idle time of the engine right before the engine stops in order to consume the fuel in the high-pressure fuel supply system (see Japanese Patent Application Publication No. 2004-293354 (JP 2004-293354 A), for example). This engine reduces the fuel pressure in the high-pressure fuel supply system so that it is lower than the target fuel pressure when the engine is restarted, by consuming fuel in the high-pressure fuel supply system. As a result, a decrease in restarting performance of the engine can be inhibited.

Meanwhile, there is a so-called dual injection type engine in which both in-cylinder injection and port injection, that injects fuel into an intake port, are possible. In this kind of dual injection type engine, the ratio of in-cylinder injection to port injection is switched according to the running conditions and the like. When the engine stops, idling is performed using only port injection.

In this kind of dual injection type engine as well, the fuel pressure in the high-pressure fuel supply system from the high-pressure tank to direct-injection injectors is high, just like the in-cylinder injection type engine described above. Therefore, there is a possibility that high-pressure fuel may leak from the high-pressure fuel supply system after the engine has stopped.

With the in-cylinder injection type engine described in JP 2004-293354 A, port injection is not taken into consideration. The dual injection type engine idles by executing only port injection when the engine stops. Therefore, even if the control described in JP 2004-293354 A that increases the idling time immediately before an in-cylinder type engine is stopped were applied to a dual injection type engine, it would only increase the time that the engine idles using only port injection in a dual injection type engine.

That is, even if the time for which a dual injection type engine idles is increased immediately before the engine stops, the fuel pressure inside the high-pressure fuel supply system for in-cylinder injection will not decrease. Therefore, in a dual injection type engine, high-pressure fuel will end up remaining in the high-pressure fuel supply system after the engine has stopped. When the fuel is first injected directly into the cylinders from the high-pressure fuel supply system after the engine is next started, fuel of a higher pressure than the target fuel pressure may be injected into the cylinders due to this remaining high-pressure fuel. In this case, the engine may vibrate or misfire due to combustion of the rich air-fuel mixture.

### SUMMARY OF THE INVENTION

The invention thus provides a control apparatus for an internal combustion engine, that is capable of reducing fuel pressure in a high-pressure fuel supply system in a dual injection type engine when the engine stops.

A first aspect of the invention relates to a control apparatus that controls a fuel supply system of an internal combustion engine of a vehicle, the fuel supply system including a low-pressure fuel supply mechanism that injects low-pressure fuel into an intake port of the internal combustion engine, and a high-pressure fuel supply mechanism that injects high-pressure fuel into a cylinder of the internal combustion engine, the control apparatus including a controller that controls a supply of fuel to the internal combustion engine from the fuel supply system. Immediately after the vehicle stops, when the internal combustion engine satisfies a predetermined condition, the control portion idles the internal combustion engine by supplying the high-pressure fuel to the internal combustion engine by the high-pressure fuel supply mechanism, and after stopping the supply of fuel by the high-pressure fuel supply mechanism, idles the internal combustion engine by supplying the low-pressure fuel to the internal combustion engine by the low-pressure fuel supply mechanism.

According to this structure, immediately after the vehicle stops, the engine is idled by supplying high-pressure fuel to the engine by the high-pressure fuel supply mechanism. As a result, the fuel pressure of the high-pressure fuel in the high-pressure fuel supply mechanism decreases. Also, the high-pressure fuel supply mechanism is stopped so that the fuel pressure in the high-pressure fuel supply mechanism does not increase. Then the engine is idled by supplying low-pressure fuel to the engine by the low-pressure fuel supply mechanism. After this, the engine is stopped if necessary.

As a result, it is possible to prevent high-pressure fuel from remaining in the high-pressure fuel supply system after a dual injection type engine stops. Therefore, vibration or misfire due to the air-fuel mixture becoming rich as a result of fuel that is at a pressure higher than the target fuel pressure being injected into the cylinders when fuel is first injected directly into the cylinders by the high-pressure fuel supply system after the engine is next started, is inhibited from occurring in the engine.

In the control apparatus described above, the predetermined condition may be that a fuel pressure in the high-pressure fuel supply mechanism be higher than a target fuel pressure.

In the control apparatus described above, when the predetermined condition is not satisfied, the controller may idle the internal combustion engine by supplying the low-pressure fuel to the internal combustion engine by the low-pressure fuel supply mechanism immediately after the vehicle stops.

The vehicle may be provided with the internal combustion engine, an electric motor, and a variable valve timing mechanism capable of changing an opening and closing timing of an intake valve or an exhaust valve of the internal combustion engine with respect to rotation of a crankshaft of the internal combustion engine, and the vehicle is able to run using at least one of the internal combustion engine and the electric motor as a drive source. At this time, the predetermined condition may be a condition that control to return the opening and closing timing of the intake valve or the exhaust valve to an initial timing that corresponds to restarting of the internal combustion engine be executed by the variable valve timing mechanism immediately after the vehicle stops, and when the predetermined condition is satisfied, the control portion may idle the internal combustion engine by supplying the high-pressure fuel to the internal combustion engine by the high-pressure fuel supply mechanism.

According to this structure, after the vehicle stops, high-pressure fuel is supplied to the engine by the high-pressure fuel supply mechanism until the opening and closing timing of the intake valve or the exhaust valve is returned by the variable valve timing mechanism to the initial timing for restarting the internal combustion engine. Therefore, the timing at which the switch is made from the high-pressure fuel supply mechanism to the low-pressure fuel supply mechanism depends on the operation by the high-pressure fuel supply mechanism of returning the opening and closing timing of the intake valve or the exhaust valve to the initial timing for restarting the internal combustion engine. Accordingly, it is not necessary to measure the actual fuel pressure in the high-pressure fuel supply system, so control is able to be simplified.

A second aspect of the invention relates to a control method of an internal combustion engine, including idling the internal combustion engine by injecting fuel into a cylinder of the internal combustion engine when a fuel pressure inside a high-pressure fuel supply mechanism is higher than a target fuel pressure, immediately after a vehicle stops, and idling the internal combustion engine by injecting fuel into an intake port of the internal combustion engine of the vehicle after idling the internal combustion engine by injecting fuel into the cylinder of the internal combustion engine.

In the control method of an internal combustion engine described above, the internal combustion engine may be idled by injecting fuel into the cylinder of the internal combustion engine until an opening and closing timing of an intake valve or an exhaust valve is returned to an initial timing that corresponds to restarting of the internal combustion engine, by a variable valve timing mechanism provided in the internal combustion engine.

According to the invention, a control apparatus for an internal combustion engine, that is capable of reducing fuel pressure in a high-pressure fuel supply system in a dual injection type engine when the engine stops, is able to be provided.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic of an engine provided with a control apparatus for an internal combustion engine according to one example embodiment of the invention;

FIG. 2 is a schematic of an intake system and an engine main body according to the example embodiment of the invention;

FIG. 3 is a flowchart illustrating operation of the control apparatus for an internal combustion engine according to the example embodiment of the invention;

FIG. 4 is a time chart showing operation of the control apparatus for an internal combustion engine according to the example embodiment of the invention;

FIG. 5 is a schematic of a hybrid vehicle provided with the control apparatus for an internal combustion engine according to the example embodiment of the invention;

FIG. 6 is a perspective view of an overall variable valve timing mechanism of the hybrid vehicle provided with the control apparatus for an internal combustion engine according to the example embodiment of the invention; and

FIG. 7 is a perspective view of the main portions of the variable valve timing mechanism of the hybrid vehicle provided with the control apparatus for an internal combustion engine according to the example embodiment of the invention.

### DETAILED DESCRIPTION OF EMBODIMENTS

Example embodiments of the invention will now be described with reference to the accompanying drawings. In the example embodiments, the invention is applied to a fuel supply system of a gasoline engine vehicle, but the invention is not limited to being applied to a gasoline engine vehicle. That is, the invention may also be applied to a hybrid vehicle or a diesel engine vehicle. The control apparatus for an internal combustion engine according to the example embodiments is installed in a dual injection type internal combustion engine that uses both in-cylinder injection and port injection, such as an in-line four-cylinder gasoline engine, for example.

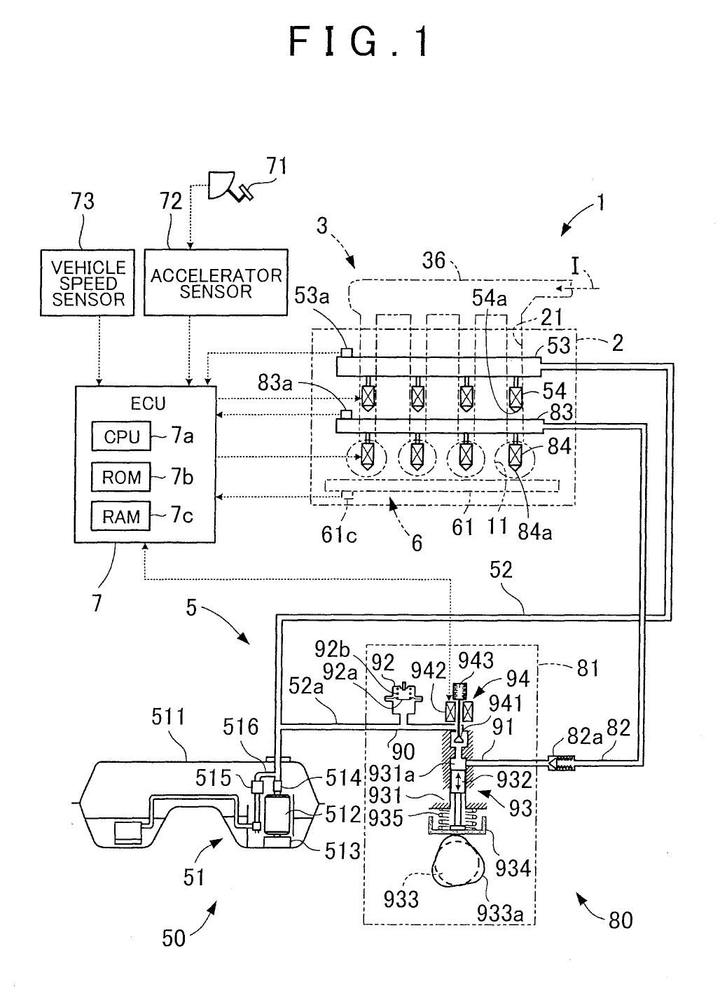

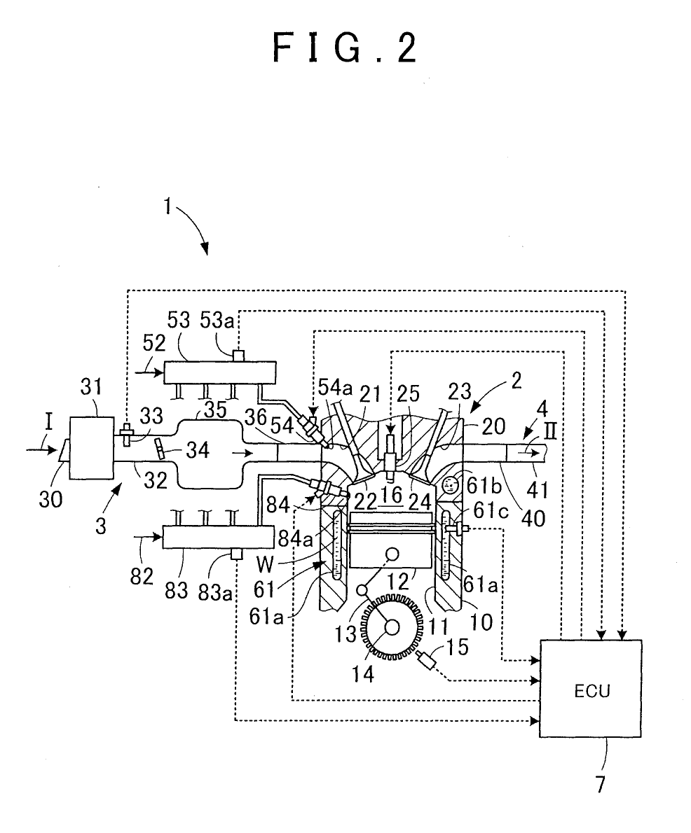

The structure of the example embodiment will now be described. As shown in FIGS. 1 and 2, an engine 1 includes an engine main body 2, an intake system 3, and exhaust system 4, a fuel supply system 5, a cooling system 6, and an ECU (Electronic Control Unit) 7 that serves as the control apparatus for the internal combustion engine.

The engine main body 2 includes a cylinder block 10 and a cylinder head 20. The cylinder block 10 and the cylinder head 20 include four cylinders 11. The cylinders 11 may be provided such that the longitudinal direction thereof is the vertical direction. To simplify the description, the cylinders 11, as well as other parts that are provided in plurality, may hereinafter be described in the singular.

The cylinder block 10 includes a piston 12, a connecting rod 13, a crankshaft 14, and a crank angle sensor 15. The piston 12 is provided so as to be able to move in a reciprocating manner inside the cylinder 11. The piston 12 is rotatably connected to the connecting rod 13. The connecting rod 13 is rotatably connected to the crankshaft 14. The crank angle sensor 15 detects the rotation speed of the crankshaft 14 and outputs a signal indicative thereof to the ECU 7.

In the engine main body 2, a combustion chamber 16 is formed by the cylinder block 10, the cylinder head 20, and the piston 12. In the engine main body 2, a mixture of air and fuel (i.e., an air-fuel mixture) is combusted in the combustion chamber 16, causing the piston 12 to move in a reciprocating manner, which in turn causes the crankshaft 14 to rotate via the connecting rod 13.

The cylinder head 20 includes an intake port 21, an intake valve 22, an intake camshaft, not shown, an exhaust port 23, an exhaust valve 24, an exhaust camshaft, not shown, and a spark plug 25. The intake port 21 communicates an intake passage of the intake system 3 with the combustion chamber 16. The intake valve 22 opens and closes communication between the intake port 21 and the combustion chamber 16 by raising and lowering, thereby controlling the introduction of intake air I into the combustion chamber 16 from the intake passage of the intake system 3. The intake camshaft raises and lowers the intake valve 22.

The exhaust port 23 communicates the combustion chamber 16 with an exhaust passage of the exhaust system 4. The exhaust valve 24 opens and closes communication between the combustion chamber 16 and the exhaust port 23 by raising and lowering, thereby controlling the discharge of exhaust gas G into the exhaust passage of the exhaust system 4 from the combustion chamber 16. The exhaust camshaft raises and lowers the exhaust valve 24.

The intake valve 22 communicates the combustion chamber 16 with the intake passage when open, and the exhaust valve 24 communicates the combustion chamber 16 with the exhaust passage when open. When the piston 12 moves downward while the intake valve 22 is open such that the combustion chamber 16 is communicated with the intake passage, the intake air I is drawn into the combustion chamber 16 through the intake passage. When the piston 12 moves upward while the exhaust valve 24 is open such that the combustion chamber 16 is communicated with the exhaust passage, the exhaust gas II is discharged from the combustion chamber 16 through the exhaust passage.

The spark plug 25 is provided exposed inside the combustion chamber 16 such that spark ignition is possible. The ignition timing of the spark plug 25 is controlled by the ECU 7.

The intake system 3 includes an intake inlet pipe 30, an air cleaner 31, an intake pipe 32, an airflow meter 33, a throttle valve 34, a surge tank 35, and an intake manifold 36. The air cleaner 31 purifies the intake air I at an upstream portion of the intake system 3 by removing coarse particulates and the like from it using a built-in filter. The airflow meter 33 detects the flowrate of the intake air I.

The throttle valve 34 is provided between the air cleaner 31 and the surge tank 35. The flowrate of the intake air I supplied to each cylinder 11 is regulated by electronically controlling the throttle valve 34. The intake manifold 36 connects the intake pipe 32 to each cylinder 11.

The intake air I flows from the intake inlet pipe 30 to the engine main body 2 via the air cleaner 31, the throttle valve 34, the surge tank 35, and the intake manifold 36, in this order, and then flows into the cylinders 11. The intake system 3 is connected to the engine main body 2 by the intake manifold 36 being connected to the cylinders 11.

The exhaust system 4 includes an exhaust manifold 40, an exhaust gas pipe 41, and an exhaust after-treatment device, not shown.

The exhaust gas II that has been discharged from the cylinders 11 flows through the exhaust manifold 40. The engine main body 2 is connected to the exhaust system 4 by this exhaust manifold 40 being connected to the cylinders 11. The exhaust gas pipe 41 connects the exhaust manifold 40 to the exhaust after-treatment device.

The fuel supply system 5 includes a low-pressure fuel supply mechanism 50 and a high-pressure fuel supply mechanism 80. The fuel supply system 5 pressurizes the fuel and then supplies it (i.e., the pressurized fuel) to the engine main body 2.

The low-pressure fuel supply mechanism 50 includes a fuel pumping portion 51, a low-pressure fuel line 52, a low-pressure delivery pipe 53, and low-pressure injectors 54.

The fuel pumping portion 51 includes a fuel tank 511, a feed pump unit 512, a suction filter 513, a fuel filter 514, a fuel pressure control valve 515, and a fuel conduit 516 that connects these together.

The fuel tank 511 stores fuel such as gasoline to be consumed by the engine main body 2. The feed pump unit 512 has a built-in feed pump, not shown, and is driven and stopped based on an ON/OFF command signal output from the ECU 7.

The feed pump unit 512 is able to pressurize fuel drawn up from within the fuel tank 511 to a certain pressure within a pressure range of less than 1 [MPa], for example, and discharge this pressurized fuel. The feed pump unit 512 is able to change the discharge pressure [MPa] and the discharge rate [m³/sec] per unit time by being controlled by the ECU 7.

That is, the discharge pressure and the discharge rate per unit time are able to be variably controlled by the ECU 7 controlling the driving and the rotation speed of the feed pump unit 512 with the ON/OFF signal. The feed pump unit 512 is a variable fuel flowrate pump or a variable fuel pressure pump that is capable of increasing at least one of the supply flowrate and the supply pressure of fuel to the low-pressure fuel supply mechanism 50 and the high-pressure fuel supply mechanism 80.

The suction filter 513 is provided at the inlet of the feed pump unit 512, and prevents foreign matter from being drawn into the feed pump. The fuel filter 514 is provided at the outlet of the feed pump unit 512, and removes foreign matter in the fuel being discharged.

The fuel pressure control valve 515 incorporates a diaphragm, not shown, that receives the pressure of the fuel discharged from the feed pump unit 512 in the valve-opening direction, and a compression coil spring, also not shown, that urges this diaphragm in the valve-closing direction. The fuel pressure control valve 515 opens when the pressure of the fuel received by the diaphragm exceeds a set pressure, and stays closed while the pressure of the fuel received by the diaphragm is less than the set pressure. As a result, the fuel pressure control valve 515 regulates the pressure of the fuel discharged into the low-pressure fuel line 52 to a preset low-pressure supply pressure such as 400 [kPa], for example.

The low-pressure fuel line 52 connects the fuel pumping portion 51 to the low-pressure delivery pipe 53. The low-pressure fuel line 52 is an arbitrary member that forms a fuel passage, and is not limited to a fuel pipe. For example, the low-pressure fuel line 52 may be a single member through which a fuel passage is formed, or it may be a plurality of members between which a fuel passage is formed.

The low-pressure delivery pipe 53 is connected to the low-pressure fuel line 52 at one end side in the direction in which the cylinders 11 are arranged in a line (hereinafter referred to as the “in-line arrangement direction of the cylinders 11”). The low-pressure injectors 54 are connected to the low-pressure delivery pipe 53 at the same intervals as the intake ports 21 corresponding to the cylinders 11 in the in-line arrangement direction of the cylinders 11. The low-pressure delivery pipe 53 distributes the fuel from the fuel pumping portion 51 at even pressure to the low-pressure injectors 54. A low-pressure fuel pressure sensor 53a that detects the fuel pressure inside of the low-pressure delivery pipe 53 is mounted to the low-pressure delivery pipe 53.

The low-pressure injectors 54 are provided as port injection injectors, with each having a nozzle hole portion 54a that is exposed inside the intake port 21 corresponding to each cylinder 11. Each of the low-pressure injectors 54 is formed by a fuel injection valve that includes an electromagnetic valve portion, not shown, that is driven by an injection command signal from the ECU 7, and a nozzle portion, also not shown, that opens the valve to inject fuel into the intake port 21 from the nozzle hole portion 54a when the electromagnetic valve portion is energized. The pressurized fuel in the low-pressure delivery pipe 53 is injected into the intake port 21 from the nozzle hole portion 54a of the low-pressure injector 54 by opening the valve in one of the plurality of low-pressure injectors 54.

The high-pressure fuel supply mechanism 80 includes a high-pressure pump portion 81, a high-pressure fuel line 82, a high-pressure delivery pipe 83, and high-pressure injectors 84.

The high-pressure pump portion 81 includes an upstream conduit 90, a downstream conduit 91, a pulsation damper 92, a high-pressure pump main body 93, and an electromagnetic spill valve 94. The high-pressure pump portion 81 is attached to the upper side of the cylinder head 20, and connected between the low-pressure fuel line 52 and the high-pressure fuel line 82. The upstream conduit 90 is connected to a branch pipe 52a of the low-pressure fuel line 52. The downstream conduit 91 is connected to the high-pressure fuel line 82.

The pulsation damper 92 is provided in the upstream conduit 90, and includes an elastic diaphragm 92a that receives fuel pressure, and a compression coil spring 92b. The internal volume of the pulsation damper 92 is changed by elastic deformation of the diaphragm 92a, so as to suppress pressure pulsation of the fuel in the upstream conduit 90.

The high-pressure pump main body 93 includes a pump housing 931, a plunger 932, a camshaft 933, a lifter 934, and a return spring 935.

The pump housing 931 has a round tube-shaped pressurizing chamber 931a formed inside. The plunger 932 has a round tube-shape and is slidably provided inside the pump housing 931. The volume of the pressurizing chamber 931a changes as the plunger 932 slides. The camshaft 933 is provided on a portion of the exhaust camshaft of the engine main body 2, and has a cam 933a for driving a pump.

The lifter 934 is integrated with the plunger 932, and slides the plunger 932 by being pushed on by the cam 933a. The return spring 935 is formed by a compression coil spring provided between the pump housing 931 and the lifter 934, and urges the lifter 934 against the cam 933a.

In the high-pressure pump main body 93, the work of drawing in, pressurizing, and discharging fuel from the feed pump unit 512 is accomplished by changing the volume of the pressurizing chamber 931a by the reciprocating movement of the plunger 932.

The high-pressure pump main body 93 pressurizes fuel introduced into the pressurizing chamber 931a from the low-pressure fuel line 52 from approximately 400 [kPa], for example, to approximately 4 [MPa] to 13 [MPa], for example, and then discharges this pressurized fuel to the high-pressure fuel line 82.

The electromagnetic spill valve 94 includes a valve body 941, an electromagnetically-driven coil 942, and a pressing spring 943.

The valve body 941 is able to open and close communication between the upstream conduit 90 and the pressurizing chamber 931a. The electromagnetically-driven coil 942 electromagnetically drives the valve body 941 in response to being energized by the ECU 7. The pressing spring 943 is formed by a compression coil spring, and constantly urges the valve body 941 in the open direction.

When the electromagnetically-driven coil 942 is not being driven,. i.e., is in a de-energized state, the valve body 941 opens the valve to introduce fuel delivered from the feed pump unit 512 into the pressurizing chamber 931a. On the other hand, when the electromagnetically-driven coil 942 is being driven, i.e., is in an energized state, the valve body 941 closes the valve to allow the high-pressure pump main body 93 to pressurize and discharge fuel.

The electromagnetic spill valve 94 has a check valve function that prevents high-pressure fuel from flowing back when the electromagnetic spill valve 94 closes in response to a signal input from the ECU 7. On the other hand, when the electromagnetic spill valve 94 opens in response to a signal input from the ECU 7, fuel is allowed to be drawn into the pressurizing chamber 931a or fuel inside the pressurizing chamber 931a is allowed to leak out into the low-pressure fuel line 52, according to the displacement of the plunger 932.

When the electromagnetically-driven coil 942 is energized, the electromagnetic spill valve 94 closes off the pressurizing chamber 931a with the valve body 941. Then the electromagnetic spill valve 94 draws fuel into the pressurizing chamber 931a, pressurizes the fuel in the pressurizing chamber 931a, and discharges the fuel from the pressurizing chamber 931a, all by changing the volume of the pressurizing chamber 931a by the reciprocating movement of the plunger 932.

The high-pressure fuel line 82 is formed by a conduit that connects the high-pressure pump portion 81 to the high-pressure delivery pipe 83, and has a check valve 82a provided midway therein. The high-pressure fuel line 82 is an arbitrary member that forms a fuel passage, and is not limited to a fuel pipe. For example, the high-pressure fuel line 82 may also be a single member through which a fuel passage is formed, or it may be a plurality of members between which a fuel passage is formed.

The check valve 82a is provided near the high-pressure pump portion 81. The check valve 82a opens when the fuel pressure on the high-pressure pump portion 81 side becomes, for example, approximately 100 [kPa] higher than the fuel pressure on the high-pressure injector 84 side. On the other hand, the check valve 82a closes when the pressure on the high-pressure pump portion 81 side becomes approximately equal to or less than the pressure on the high-pressure injectors 84 side.

The high-pressure delivery pipe 83 is connected to the high-pressure fuel line 82 at one end side in the in-line arrangement direction of the cylinders 11. The high-pressure injectors 84 are connected to the high-pressure delivery pipe 83 at the same intervals as the cylinders 11 in the in-line arrangement direction of the cylinders 11. The high-pressure delivery pipe 83 distributes the fuel from the high-pressure pump portion 81 at even pressure to the high-pressure injectors 84. A high-pressure fuel pressure sensor 83a that detects the fuel pressure inside of the high-pressure delivery pipe 83 is mounted to the high-pressure delivery pipe 83.

The high-pressure injectors 84 are provided as in-cylinder injection injectors, with each having a nozzle hole portion 84a that is exposed inside the combustion chamber 16 of each cylinder 11. Each of the high-pressure injectors 84 is formed by a fuel injection valve that includes an electromagnetic valve portion, not shown, that is driven by an injection command signal from the ECU 7, and a nozzle portion, also not shown, that opens the valve to inject fuel into the combustion chamber 16 from the nozzle hole portion 84a when the electromagnetic valve portion is energized. The pressurized fuel in the high-pressure delivery pipe 83 is injected into the combustion chamber 16 from the nozzle hole portion 84a of the high-pressure injector 84 by opening the valve in one of the plurality of high-pressure injectors 84.

The cooling system 6 includes a water jacket 61, a water pump, not shown, and a radiator, also not shown. Coolant W is circulated from the water pump, to the water jacket 61, then to the radiator, and then back again to the water pump.

The water jacket 61 includes a cylinder block water jacket 61a formed in the cylinder block 10, a cylinder head water jacket 61b formed in the cylinder head 20, and a coolant temperature sensor 61c. The cylinder block water jacket 61a and the cylinder head water jacket 61b are connected together and provided around each of the cylinders 11. The water jacket 61 cools the engine main body 2 by circulating the coolant W inside of it (i.e., the water jacket 61).

The ECU 7 includes a CPU (Central Processing Unit) 7a, ROM (Read Only Memory) 7b in which fixed data is stored, RAM (Random Access Memory) 7c in which data is temporarily stored, backup memory, not shown, formed by rewritable nonvolatile memory, an input interface circuit, not shown, that has an A/D converter and a buffer and the like, and an output interface circuit, also not shown, that has a drive circuit and the like. ON/OFF signals from an ignition switch of a vehicle are input to the ECU 7, and electric power is supplied from a battery, not shown.

Various sensors are connected to the ECU 7. These sensors include the airflow meter 33, the crank angle sensor 15, the low-pressure fuel pressure sensor 53a, the high-pressure fuel pressure sensor 83a, and the coolant temperature sensor 61c, all of which are described above, as well as an accelerator sensor 72 that detects a depression angle of an accelerator pedal 71, a vehicle speed sensor 73 that detects a vehicle speed of the vehicle, a fuel temperature sensor, not shown, that detects a temperature of the fuel, and an intake air temperature sensor, also not shown, that detects a temperature of the intake air.

The ECU 7 calculates a basic injection quantity necessary for each combustion, based on an accelerator operation amount detected by the accelerator sensor 72, an intake air amount detected by the airflow meter 33, and an engine speed detected by the crank angle sensor 15, and the like, according to a control program stored in advance in the ROM 7b. The ECU 7 then calculates a fuel injection quantity that has undergone an air-fuel ratio feedback correction and various other corrections according to the operating state of the engine 1, based on the basic injection quantity and set value information stored in advance in the backup memory and the like. The ECU 7 then outputs an injection command signal and a valve driving command signal to drive the electromagnetic spill valve 94, and the like, to the low-pressure injectors 54 and the high-pressure injectors 84 at the right time, based on the calculated fuel injection quantity.

The ECU 7 adjusts the amount of fuel that leaks out through the electromagnetic spill valve 94 from the pressurizing chamber 931a to the low-pressure fuel line 52. The ECU 7 is able to control the pressure of fuel supplied from the high-pressure pump main body 93 to the high-pressure delivery pipe 83 to an optimum fuel pressure according to the operating state of the engine 1 and the injection characteristics of the high-pressure injectors 84, by at least this adjustment.

For example, the ECU 7 is able to set an ON time, during which the electromagnetically-driven coil 942 of the electromagnetic spill valve 94 is in an energized state, and an OFF time, during which the electromagnetically-driven coil 942 of the electromagnetic spill valve 94 is not in an energized state, within a certain signal cycle. The ECU 7 is able to adjust the amount of fuel that leaks out through the electromagnetic spill valve 94 from the pressurizing chamber 931a, by changing the ratio of ON time within the signal cycle (i.e., 0% to 100%; hereinafter, referred to as the “duty ratio”).

When the engine 1 is started, the ECU 7 first performs fuel injection using the low-pressure injectors 54. When the fuel pressure inside the high-pressure delivery pipe 83 that is detected by the high-pressure fuel pressure sensor 83a exceeds a preset pressure value, the ECU 7 determines that the fuel pressure has reached a fuel pressure level necessary to execute fuel injection using the high-pressure injectors 84. Based on this determination, the ECU 7 starts to output an injection command signal to the high-pressure injectors 84.

The ECU 7 controls the fuel injection in the manners described in the examples below. For example, during normal operation, the ECU 7 executes in-cylinder injection using the high-pressure injectors 84, and under a specific operating condition in which the air-fuel mixture formation is insufficient with in-cylinder injection, such as when the engine 1 is warming up at startup or when the engine 1 is operating at a low speed and a high load, the ECU 7 executes port injection in combination with in-cylinder injection. In another example, the ECU 7 executes in-cylinder injection using the high-pressure injectors 84 during normal operation, and executes port injection using the low-pressure injectors 54 at times such as when the engine 1 is operating at a high speed and a high load which is when port injection is effective. Alternatively, the ECU 7 operates the engine 1 using only port injection and no in-cylinder injection (hereinafter, this will be referred to as “PFI operation”).

When the accelerator is off (that is, when the accelerator pedal 71 is released, i.e., not being depressed) when the vehicle is traveling at a high speed, for example, the ECU 7 stops energizing the electromagnetically-driven coil 942 of the electromagnetic spill valve 94, thereby placing the high-pressure pump portion 81 in a fuel-cut state in which the high-pressure pump portion 81 is unable to pressurize the fuel.

Immediately after the vehicle stops, the ECU 7 idles the engine 1 by supplying high-pressure fuel to the engine 1 using the high-pressure fuel supply mechanism 80, thereby lowering the fuel pressure of the high-pressure fuel in the high-pressure fuel supply mechanism 80. The ECU 7 sets a target fuel pressure when using the high-pressure fuel supply mechanism 80 beforehand, and stores this target fuel pressure. After the ECU 7 stops supplying fuel using the high-pressure fuel supply mechanism 80, the ECU 7 idles the engine 1 by supplying low-pressure fuel to the engine 1 using the low-pressure fuel supply mechanism 50.

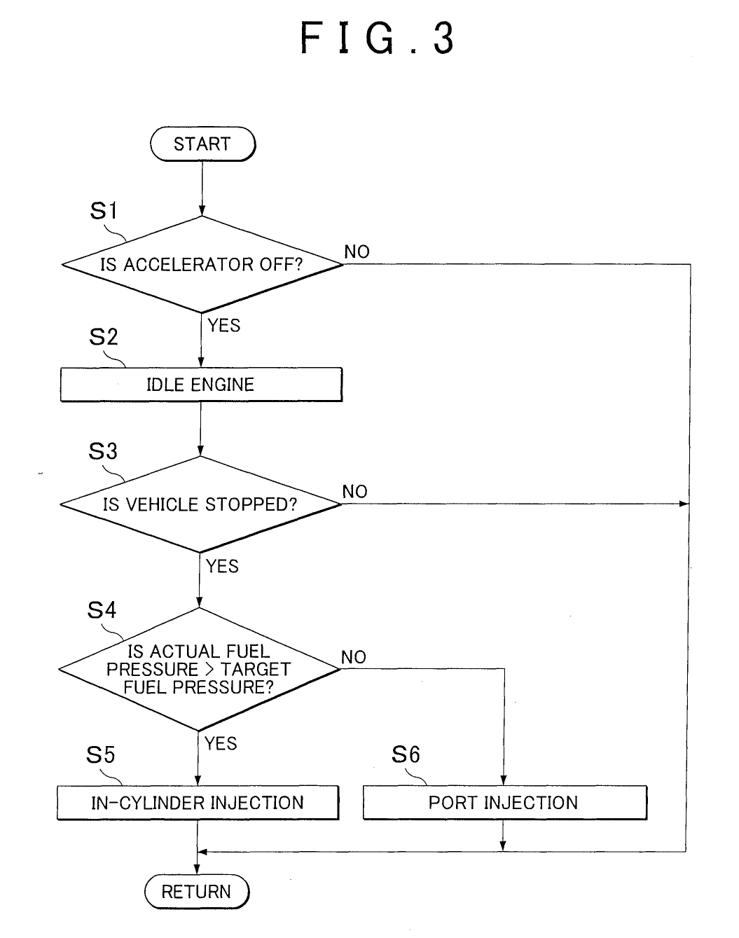

Next, the operation of the example embodiment will be described. The flowchart shown in FIG. 3 is a program of a fuel supply routine for an internal combustion engine that is executed, using the RAM 7c as the work area, by the CPU 7a of the ECU 7. This program of the fuel supply routine for an internal combustion engine is stored in the ROM 7b of the ECU 7.

In the fuel supply system 5 of this example embodiment structured as described above, this fuel supply routine for an internal combustion engine is executed at intervals of time (such as every 10 milliseconds) determined in advance by the ECU 7.

The ECU 7 determines whether the accelerator pedal 71 is released, i.e., whether the accelerator is off (step S1). This determination is made by the ECU 7 based on whether the accelerator operation amount detected by the accelerator sensor 72 is 0. When the ECU 7 determines that the accelerator pedal 71 is not released, i.e., that the accelerator is not off (i.e., NO in step S1), the process returns to the main routine.

When the ECU 7 determines that the accelerator pedal 71 is released, i.e., that the accelerator is off (i.e., YES in step S1), the ECU 7 performs control to reduce the speed of the engine 1 so that the engine 1 idles, by reducing the amount of fuel supplied to the engine 1 from the fuel supply system 5 or setting that amount to zero (step S2).

The ECU 7 determines whether the vehicle is stopped (step S3). This determination is made by the ECU 7 based on whether the vehicle speed detected by the vehicle speed sensor 73 is zero. When the ECU 7 determines that the vehicle is not stopped (i.e., NO in step S3), the process returns to the main routine.

When the ECU 7 determines that the vehicle is stopped (i.e., YES in step S3), the ECU 7 determines whether an actual fuel pressure in the high-pressure fuel supply system is higher than the preset target fuel pressure (step S4). This determination is made by the ECU 7 based on comparative results of the actual fuel pressure on the high pressure side detected by the high-pressure fuel pressure sensor 83a and the target fuel pressure.

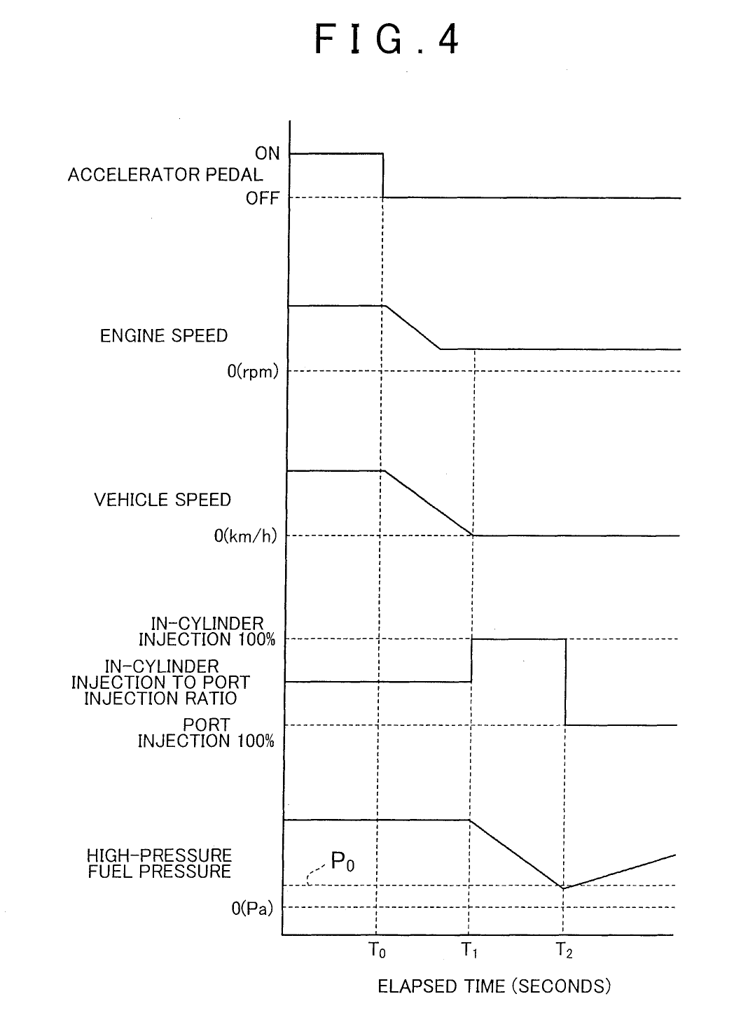

When the ECU 7 determines that the actual fuel pressure in the high-pressure fuel supply system is higher than the target fuel pressure (i.e., YES in FIG. 4), the ECU 7 performs control to idle the engine 1 using only in-cylinder injection by activating the high-pressure fuel supply mechanism 80 (step S5). That is, if the engine 1 is stopped while the actual fuel pressure in the high-pressure fuel supply system is higher than the target fuel pressure, high-pressure fuel will end up remaining in the high-pressure fuel supply system, so the ECU 7 performs control to reduce the fuel pressure in the high-pressure fuel supply system by idling the engine 1 using in-cylinder injection.

On the other hand, when the ECU 7 determines that the actual fuel pressure in the high-pressure fuel supply system is equal to or less than the target fuel pressure (i.e., NO in FIG. 4), the ECU 7 performs control to idle the engine 1 with PFI operation using only port injection by operating the low-pressure fuel supply mechanism 50.

Operation of the engine 1 when a driver has released the accelerator pedal 71 while the vehicle is running as described above will be described with reference to the time chart shown in FIG. 4.

As shown in FIG. 4, while the vehicle is running, percentages of both in-cylinder injection and port injection of the supply of fuel to the engine 1 are 50%, for example. When the driver releases the accelerator pedal 71 at time T₀, the ECU 7 performs control to reduce the amount of fuel supplied from the fuel supply system 5 to the engine 1. As a result, the speed of the engine 1 decreases, and consequently, the vehicle speed decreases.

If the actual fuel pressure in the high-pressure fuel supply system is greater than a target fuel pressure P₀ when the vehicle speed is zero at time T₁, the ECU 7 performs control to idle the engine 1 using only in-cylinder injection by operating the high-pressure fuel supply mechanism 80. Idling the engine 1 using in-cylinder injection reduces the fuel pressure in the high-pressure fuel supply system.

If the actual fuel pressure in the high-pressure fuel supply system is equal to or less than the target fuel pressure P₀ at time T₂, the ECU 7 performs control to idle the engine 1 by PFI operation using only port injection by operating the low-pressure fuel supply mechanism 50. As a result, the actual fuel pressure in the high-pressure fuel supply system is able to be maintained at approximately the target fuel pressure P₀.

If the engine 1 is stopped thereafter, the actual fuel pressure in the high-pressure fuel supply system is able to be kept at approximately the target fuel pressure P₀. Of, if the engine 1 is not stopped and the accelerator pedal 71 is depressed by the driver, the amount of fuel that is supplied will increase, so the speed of the engine 1 will increase.

As described above, with the control apparatus for an internal combustion engine according to this example embodiment, immediately after the vehicle stops, the fuel pressure of the high-pressure fuel in the high-pressure fuel supply system is reduced by idling the engine 1 by supplying high-pressure fuel to the engine 1 using the high-pressure fuel supply mechanism 80. This makes it possible to prevent high-pressure fuel from remaining in the high-pressure fuel supply system after the dual injection type engine 1 stops. As a result, vibration or misfire due to the air-fuel mixture becoming rich as a result of fuel that is at a pressure higher than the target fuel pressure being injected into the cylinders 11 when fuel is first directly injected into the cylinders 11 by the high-pressure fuel supply system after the engine 1 is next started, is inhibited from occurring in the engine 1.

As described above, it is possible to inhibit the pressure of fuel in the high-pressure fuel supply system from becoming excessively high while the vehicle is stopped, so it is possible to eliminate a relief mechanism in the high-pressure fuel supply system. Therefore, there is no need to provide a conduit for the relief mechanism from the high-pressure delivery pipe 83 to the fuel tank 511, for example, so costs can be reduced compared with when a relief mechanism is provided.

In the control apparatus for an internal combustion engine according to the example embodiment described above, the ratio of fuel to be used for in-cylinder injection and port injection (hereinafter also referred to as the “in-cylinder injection to port injection ratio”) is determined based on the comparative results of the actual fuel pressure in the high-pressure fuel supply system and the target fuel pressure P₀. The control apparatus for an internal combustion engine of the invention is not limited to this. For example, the in-cylinder injection to port injection ratio may also be determined based on a temperature such as the fuel temperature, the intake air temperature, or the coolant temperature. Alternatively, the in-cylinder injection to port injection ratio may be determined based on a combination of a temperature such as the fuel temperature, the intake air temperature, or the coolant temperature, and the comparative results of the actual fuel pressure in the high-pressure fuel supply system and the target fuel pressure P₀.

In the control apparatus for an internal combustion engine according to the example embodiment described above, the control apparatus is applied to a gasoline vehicle. The control apparatus for an internal combustion engine of the invention is not limited to this. For example, the control apparatus may also be applied to a hybrid vehicle or a diesel engine vehicle.

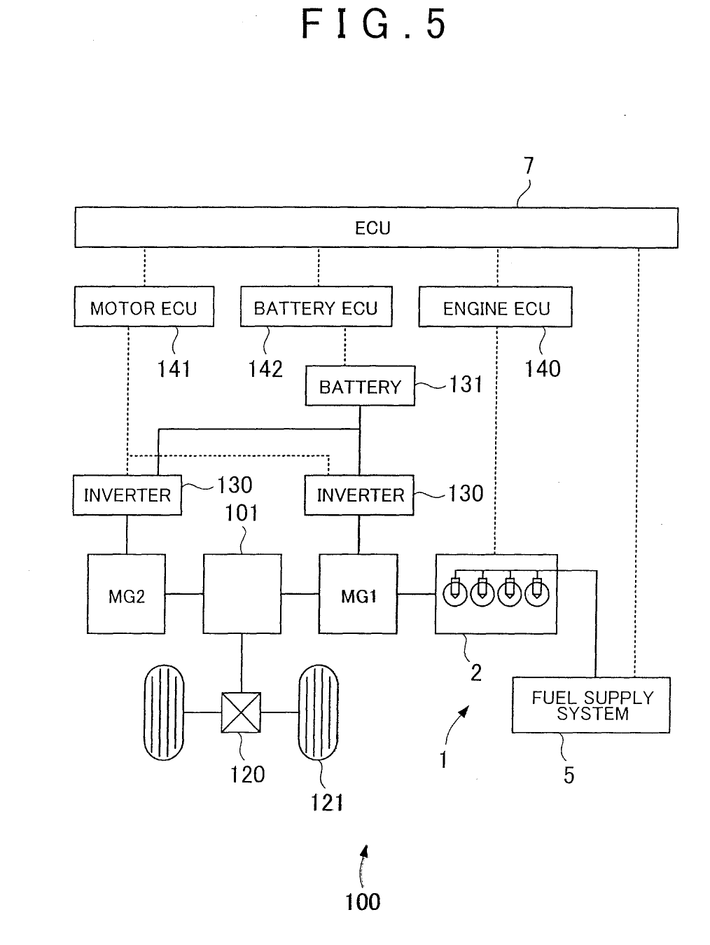

Now a case will be described in which the control apparatus for an internal combustion engine is applied to a hybrid vehicle 100. As shown in FIG. 5, the hybrid vehicle 100 is provided with an engine 1, a power splitting/combining device 101 that is connected to the engine 1, a motor MG1 and a motor MG2 that serve as electric motors that are connected to the power splitting/combining device 101, and an ECU 7 that controls the overall vehicle. This hybrid vehicle 100 is able to run using at least one of the engine 1 and the motor MG2 as a drive source.

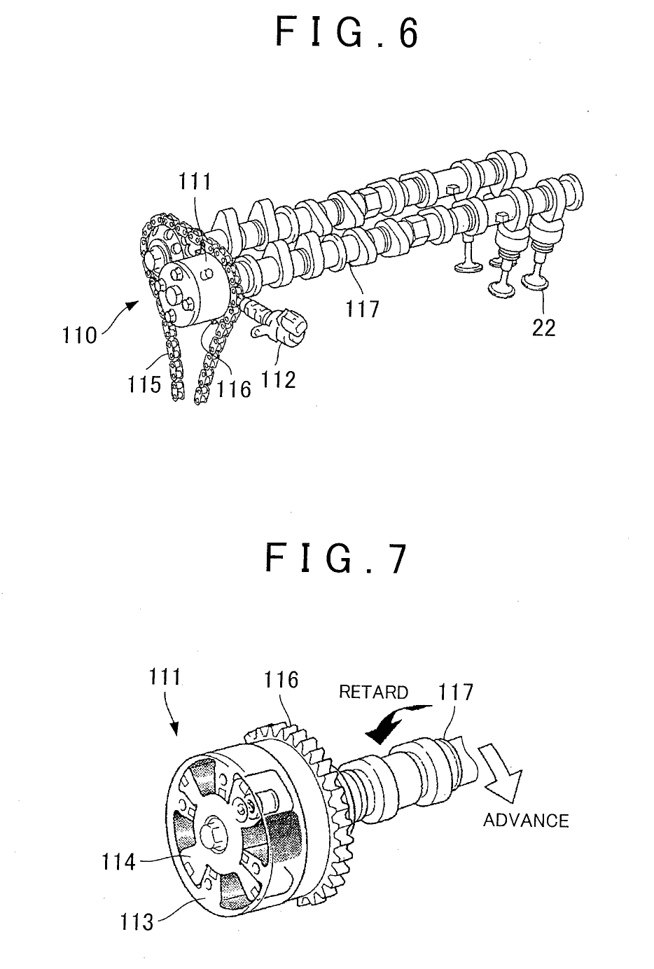

The engine 1 has a structure like the engine 1 described above, so reference characters will be the same and a detailed description thereof will be omitted. As shown in FIGS. 6 and 7, the engine 1 includes a variable valve timing mechanism 110 capable of continuously (i.e., smoothly) changing the opening and closing timing of the intake valves 22. The variable valve timing mechanism 110 includes a VVT controller 111 and an oil control valve 112.

The VVT controller 111 is a vane-type controller that includes a housing portion 113 and a vane portion 114. The housing portion 113 is fixed to a timing gear 116. The timing gear 116 is connected to the crankshaft 14 via a timing chain 115. The vane portion 114 is fixed to an intake camshaft 117 that opens and closes the intake valves 22. The oil control valve 112 regulates the hydraulic pressure applied to an advance chamber and a retard chamber of the VVT controller 111.

The variable valve timing mechanism 110 regulates the hydraulic pressure applied to the advance chamber and the retard chamber of the VVT controller 111 via the oil control valve 112. As a result, the vane portion 114 is rotated relative to the housing portion 113, thereby continuously (i.e., smoothly) changing the angle of the intake camshaft 117 of the opening and closing timing of the intake valves 22.

As shown in FIG. 5, a differential gear 120 is connected to the power splitting/combining device 101. Driving wheels 121 are connected to this differential gear 120. Output from the power splitting/combining device 101 is transmitted to the driving wheels via the differential gear 120. The motor MG1 and the motor MG2 are each formed by a synchronous generator-motor capable of being driving as a generator as well as being driven as a motor. The motor MG1 and the motor MG2 are each connected to an inverter 130. Both of the inverters 130 are connected to a battery 131. The ECU 7 is connected to an engine ECU 140, a motor ECU 141, and a battery ECU 142.

In the hybrid vehicle 100 described above, when a stop command for the engine 1 is generated and the vehicle stops, the ECU 7 operates the variable valve timing mechanism 110 via the engine ECU 140 and returns the opening and closing timing of the intake valves 22 to the initial timing. That is, the ECU 7 rotates the vane portion 114 and shifts it to the most retarded position that corresponds to the initial timing that is optimum for restarting the engine 1. In order to perform the operation of rotating the vane portion 114, the ECU 7 idles the engine 1 without stopping it for a predetermined waiting period of 500 milliseconds, for example, and then stops the engine 1 after this waiting period has elapsed.

Here, the ECU 7 performs control to idle the engine 1 using only in-cylinder injection by operating the high-pressure fuel supply mechanism 80. As a result, the ECU 7 is able to determine the in-cylinder injection to port injection ratio without comparing the actual fuel pressure in the high-pressure fuel supply system with the target fuel pressure, so control can be performed easily.

In the hybrid vehicle 100 described above, the variable valve timing mechanism 110 changes the opening and closing timing of the intake valves 22. The control apparatus for an internal combustion engine of the invention is not limited to this. The variable valve timing mechanism may also change the opening and closing timing of the exhaust valves 24. In this case, in order to return the opening and closing timing of the exhaust valves 24 to the initial timing when the engine 1 stops, the vane portion of the exhaust-side variable valve timing mechanism is rotated so that it moves to the most advanced position that corresponds to the initial position that is optimum for restarting the engine 1.

As described above, the control apparatus for an internal combustion engine of the invention displays the effect of being able to reduce the fuel pressure in the high-pressure fuel supply system in a dual injection type engine when the engine stops, and is useful as a control apparatus for an internal combustion engine.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

1. A control apparatus that controls a fuel supply system of an internal combustion engine of a vehicle, the fuel supply system including a low-pressure fuel supply mechanism that injects low-pressure fuel into an intake port of the internal combustion engine, and a high-pressure fuel supply mechanism that injects high-pressure fuel into a cylinder of the internal combustion engine, the control apparatus comprising:
an electronic control unit configured to control a supply of fuel to the internal combustion engine from the fuel supply system,
immediately after the vehicle stops, when the internal combustion engine satisfies a predetermined condition, the electronic control unit configured to idle the internal combustion engine by supplying the high-pressure fuel to the internal combustion engine by the high-pressure fuel supply mechanism, and after stopping the supply of fuel by the high-pressure fuel supply mechanism, the electronic control unit configured to idle the internal combustion engine by supplying the low-pressure fuel supply mechanism.

2. The control apparatus according to claim 1, wherein the predetermined condition is that a fuel pressure in the high-pressure fuel supply mechanism be higher than a target fuel pressure.

3. The control apparatus according to claim 1, wherein when the predetermined condition is not satisfied, is configured to idle the internal combustion engine by supplying the low-pressure fuel to the internal combustion engine by the low-pressure fuel supply mechanism immediately after the vehicle stops.

4. The control apparatus according to claim 1, wherein the vehicle is provided with the internal combustion engine, an electric motor, and a variable valve timing mechanism capable of changing an opening and closing timing of an intake valve or an exhaust valve of the internal combustion engine with respect to rotation of a crankshaft of the internal combustion engine, and the vehicle is able to run using at least one of the internal combustion engine and the electric motor as a drive source, and
wherein the predetermined condition is a condition that control to return the opening and closing timing of the intake valve or the exhaust valve to an initial timing that corresponds to restarting of the internal combustion engine be executed by the variable valve timing mechanism immediately after the vehicle stops; and
when the predetermined condition is satisfied, the electronic control unit is configured to idle the internal combustion engine by supplying the high-pressure fuel to the internal combustion engine by the high-pressure fuel supply mechanism.

5. A control method of an internal combustion engine, comprising:
Idling the internal combustion engine by injecting fuel into a cylinder of the internal combustion engine when a fuel pressure inside ah high-pressure fuel supply mechanism is higher than a target fuel pressure, immediately after a vehicle stops; and
Idling the internal combustion engine by injecting fuel into an intake port of the internal combustion engine of the vehicle after idling the internal combustion engine by injecting fuel into the cylinder of the internal combustion engine.

6. The control method of the internal combustion engine according to claim 5, wherein the internal combustion engine is idled by injecting fuel into the cylinder of the internal combustion engine until an opening and closing timing of an intake valve or an exhaust valve is returned to an initial timing that corresponds to restarting of the internal combustion engine, by a variable valve timing mechanism provided in the internal combustion engine.
